(19) United States
(12) Patent Application Publication
(10) Pub. No.: US 2003/0201322 A1
(43) Pub. Date: Oct. 30, 2003

(54) Adapter of compact flash memory card for various types of flash memory card

(76) Inventor: Mei-Ching Wu, Taoyuan Hsien (TW)

Correspondence Address: Leong Chi LEI, PMB #1008, 1867 Ygnacio Valley Road, WALNUT CREEK, CA, 94598, US

(21) Appl. No.: 10/133,485

(22) Filed: Apr. 29, 2002

(51) Int. Cl. G06K 7/06

(52) U.S. Cl. 235/441

(57) ABSTRACT

An compact flash memory card adapter for various types of flash memory card is disclosed. The adapter comprises a compact flash memory card connector a stamp size flash memory card insertion seat and data conversion control circuit board. By means of the adapter, the data can be converted to data format of compact flash memory card via the format of memory stick, secure digital, multimedia card/MMC or memory stick duo. As a result, any stamp size memory cards, such as memory stick, secure digital, multimedia card/MMC or memory stick duo can be provided with electronic products having compact flash memory card, facilitating insertably replacement with various types of stamp size flash memory card.

### BACKGROUND OF THE INVENTION

(a) Field of the Invention

The present invention relates to adapter of a compact flash memory card for various types of flash memory card, and in particular, an adapter provided with control circuit for converting stamp size flash memory card data format to compact flash memory card data format such that electronic appliance with compact memory card can be insertably replaced with various kinds of stamp size flash memory card.

(b) Description of the Prior Art

Flash memory cards are designed for the use with digital processing devices such as digital cameras, digital video cameras, PDA and mobile phones. The size of such device is small and facilitates portability. These memory cards are smaller than the floppy diskette that available in the market, and there are the size of a stamp or half the size of a credit card but the capacity of thereof is more than hundred of times than the computer diskette.

In the market, there are two main streams of compact memory cards, one being the compact flash memory card and the other being the Smart Media. The compact flash memory card is provided with format designed by SanDisk Corporation, USA and the largest capacity is 1 GB and is accepted by most of the users. Smart Media has a format designed by Toshiba, Japan and the largest capacity is 128 GB. These two formats are improved continuously as various types of digital data are increased.

Other types of memory cards such as stamp size memory card or Memory stick or memory stick duo are designed by Sony, Japan, other type like Secure Digital is designed by SanDisk, Matsushita and Toshiba, Multimedia Card/MMC is designed by San disk and Siemens. These memory cards will have impacts on the digital video and audio and data storage.

However, PDA, notebook computers and digital cameras employ insertion port of compact flash memory card. As a result, if new type of flash memory cards are developed, incompatibility may be occurred and a plurality of electronic data product and the stamp size flash memory cards may not be applicable. As a result, it is an object of the present invention to provide an adapter which mitigates the above drawbacks so as to provide compatibility for various stamp size flash memory cards with the electronic data products.

### SUMMARY OF THE INVENTION

It is an object of the present invention to provide an adapter of compact flash memory card for various types of flash memory card, wherein the existing insertion port of compact flash memory card or the insertion port of PCNCIA of electronic digital data appliance can be used with the stamp size flash memory card, including Memory Stick, Secure Digital, Multimedia Card (MMC), or Memory Stick Duo, so as to improve the applicability of the product.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 shows a flowchart illustrating the constitution of the compact flash memory card adapter for various kinds of flash memory card in accordance with the present invention.

FIG. 2 is a perspective view illustrating the insertable connection of a PDA to the compact flash memory card adapter in accordance with the present invention.

FIG. 3 is a perspective view illustrating the insertable connection of a digital camera to the compact flash memory card adapter in accordance with the present invention.

FIG. 4 is a perspective view illustrating the insertable connection of a notebook computer to the com pact flash memory card adapter in accordance with the present invention.

### DETAILED DESCRIPTION OF THE PRESENT INVENTION

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

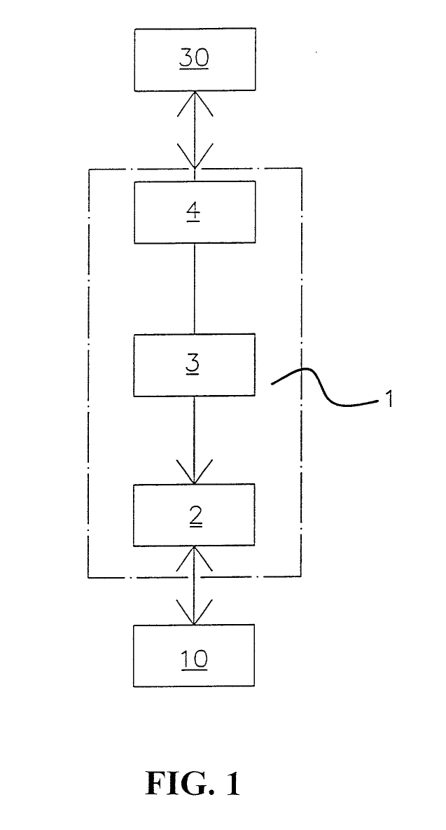

Referring to FIG. 1, there is shown a block diagram showing the constitution of the compact flash memory card adapter for various kinds of flash memory card in accordance with the present invention. The compact flash memory card adapter 1 comprises a compact flash memory card connector 2, a stamp size flash memory card insertion seat 4 and data conversion control circuit board 3. One end of the connector 2 is electrically connected to a corresponding end of the control circuit board 3 and one end of the stamp size of the insertion seat 4 is also electrically connected to a corresponding end of the control circuit board 3. The connector 2 is insertably connected to the engaging port 10 of the compact flash memory card of an electronic data product or is insertably connected to the compact flash memory card insertion port 10 of the PCMCIA/compact flash memory card adapter. By means of PCMCIA compact flash memory card adapter it is connected to the PCMCIA insertion port of electronic data product. Then various kinds of stamp size flash memory card 30 is inserted to the stamp size flash memory card insertion seat 4 such that the data format of the stamp size flash memory card 30 is converted into compact flash memory card data format by means of data conversion control circuit board 3. This facilitates electronic data product to accesses the memory data of the flash memory card 30. The commands from the electronic data product is also transmitted to the data conversion control circuit board 3 via insertion slot 10, 20 and is converted into the data format of stamp size flash memory card 30. By means of the insertion seat 4, the data write into the stamp size flash memory card 30 by means of stamp size flash memory card insertion seat 4. Therefore the electronic data product can use various size of stamp size flash memory card.

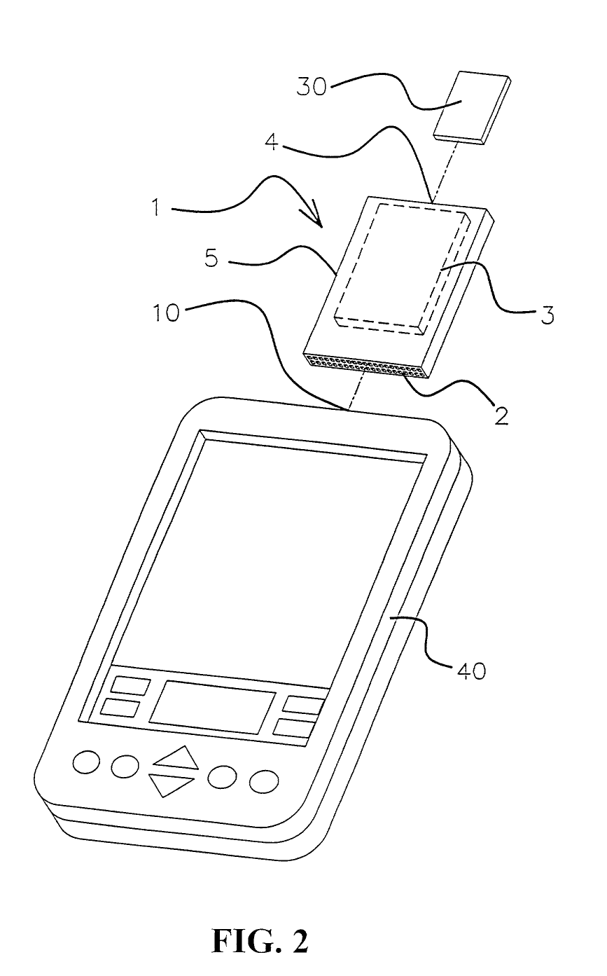

As shown in FIG. 2, a PDA 40 is insertably plugged to the cartridge 5 of the adapter in accordance with the present. One end of the cartridge 5 mounted with the compact flash memory card insertion port 10 is provided with insertion seat for the insertion of the stamp size flash memory card 30. In application, the stamp size flash memory card 30 is inserted into the insertion slot 4 and the entire structure is plugged to the insertion port 10 of the PDA 40 such that the connector 2 is insertably connected to the circuit at the port 10. Thus the PDA originally employed compact flash memory card can be extended to use stamp size flash memory card 30.

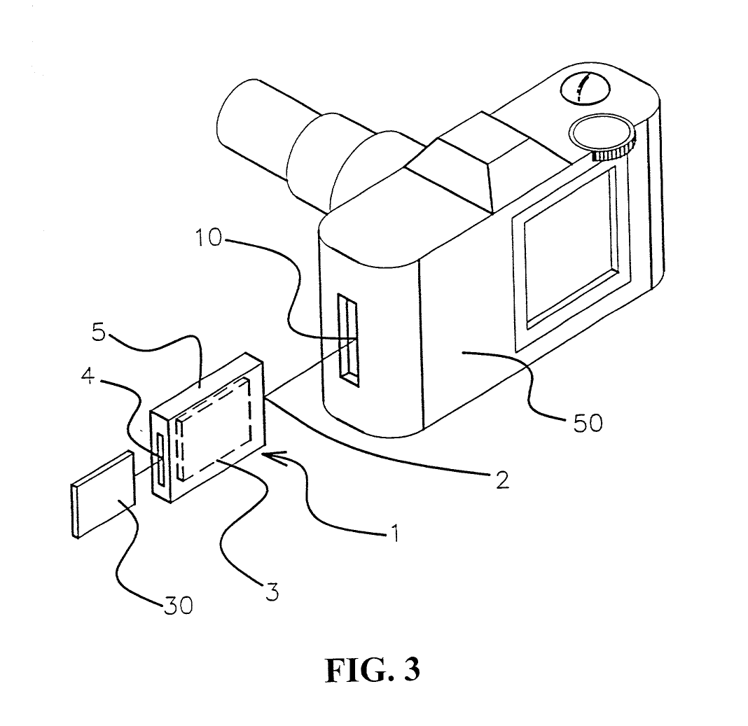

FIG. 3 shows an insertable connection of a digital camera to the adapter. The cartridge 5 of the adapter 1 is made into a size which can be inserted into the insertion port 10 of the digital camera 50. The cartridge 5 having mounted with the insertion port 10 is provided with an insertion seat 4 so that the entire stamp size flash memory card 30 can be mounted to the insertion seat 40 and the entire structure is than insertably plugged into the insertion port 10 of the digital camera 50. Thus then connector 2 is connected to the circuit within the port 10. As a result the digital camera 50 originally using the compact flash memory card is extended to use stamp size flash memory card 30. The stamp size flash memory card 30 on the adapter 1 can be replaced either by a PDA 40 or the digital camera 50, the compatible of data is thus extended.

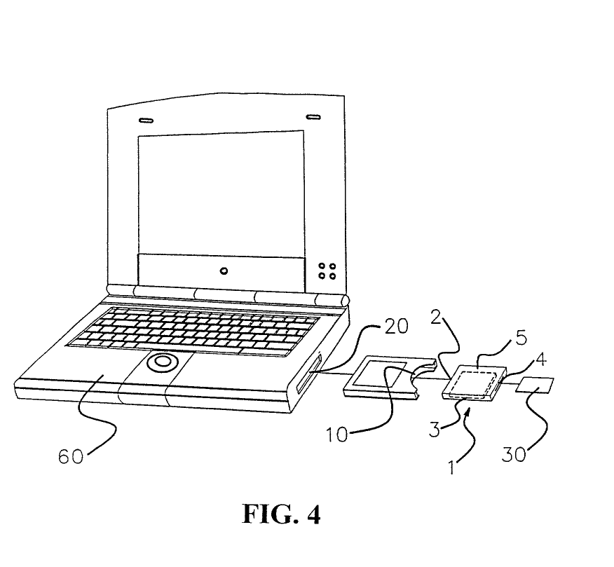

FIG. 4 shows the insertable connection of a notebook computer. The adapter 1 is made into a cartridge 5 which can be plugged into the insertion port 10 of the PCMCIA. The cartridge 5 having provided with the insertion port 10 is provided with insertion seat 4 and the flash memory card 30 is first inserted to the insertion seat 4. The entire adapter 1 is inserted to the insertion port 10 of the PCMCIA adapter 70 such that the connector 2 is connected to the circuit within the port 10. The adapter 70 is entire plugged into the PCMCIA insertion port 20 of the notebook computer 60. Thus the insertion port of the notebook computer 60 is extended for the insertion of stamp size flash memory card 30. Thus by means of replacement of stamp size flash memory card 30 within the adapter 1 and that of the digital cameral 50 and the PDA 40, the data compatibility is extended.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An adapter of compact flash memory card for various kinds of flash memory card comprising a compact flash memory card connector, a stamp size flash memory card engaging seat and a data conversion control circuit board, wherein the one end of the connector is electrically connected to a corresponding end of the control circuit board, and one end of the engaging seat of the stamp size flash memory card is electrically connected to the corresponding end of the control circuit board and the connector of the compact flash memory card is insertably connected to the insertion port of the compact flash memory card of an electronic data product, or insertably connected to the compact flash memory card insertion port and by means of the adapter is then insertably connected to the electronic data product having provided with PCMCIA insertion port so that various kinds of stamp size flash memory card are inserted into the stamp size flash memory card insertion seat so that the data format of the stamp size flash memory card is converted into data format of compact flash memory card via data conversion control circuit board, facilitating the combination of electronic data product with various kinds of stamp size flash memory card.

2. An adapter of compact flask for various kinds of flash memory card comprising a compact flash memory card connector, a stamp size flash memory card insertion seat, a data converting control circuit board, and a cartridge enclosing the external package, the entire structure covered by the cartridge can be directly plugged into the insertion port of the compact flash memory card of an electronic data product or the insertion port of PCMCIA and one end of the compact flash memory card insertion port is provided with insertion seat allowing the insertion for the stamp size flash memory card.

3. The adapter of claim 1, wherein the stamp size flash memory card is a memory stick.

4. The adapter of claim 1, wherein the stamp size flash memory card is a memory stick duo.

5. The adapter of claim 1, wherein the stamp size flash memory card is a secure digital.

6. The adapter of claim 1, wherein the stamp size flash memory card is a multimedia card (MMC).

7. The adapter of claim 2, wherein the stamp size flash memory card is a memory stick.

8. The adapter of claim 2, wherein the stamp size flash memory card is a memory stick duo.

9. The adapter of claim 2, wherein the stamp size flash memory card is a secure digital.

10. The adapter of claim 2, wherein the stamp size flash memory card is a multimedia card (MMC).

11. The adapter of claim 2, wherein the insertion seat is used commonly by the secure digital and the memory stick.

12. The adapter of claim 2, wherein the insertion seat is used commonly by the secure digital and the memory stick duo.
